(19) United States
(12) Patent Application Publication
(10) Pub. No.: US 2010/0304111 A1
(43) Pub. Date: Dec. 2, 2010

(54) SOUND REDUCING AND FIRE RESISTANT SURFACE APPARATUS AND METHOD OF MAKING THE SAME

(76) Inventors: Anthony Curtis Vulpitta, Advance, NC (US); Randy Lee Bryant, Jonesville, NC (US)

Correspondence Address: SMITH MOORE LEATHERWOOD LLP, P.O. BOX 21927, GREENSBORO, NC, 27420, US

(21) Appl. No.: 12/483,421

(22) Filed: Jun. 12, 2009

Related U.S. Application Data
(60) Provisional application No. 61/183,002, filed on Jun. 1, 2009.

(51) Int. Cl. E04F 13/00; B32B 27/30; E04B 1/84; B32B 37/00

(52) U.S. Cl. 428/220; 156/244.11; 156/244.27

(57) ABSTRACT

Thin, flexible surface apparatus with sound reducing and fire resistant characteristics. The surface apparatus comprises an EVA layer and at least one fire resistant fabric layer. The EVA layer is extruded and bonded to the at least one fire resistant fabric layer. The surface apparatus may be affixed to the surface of a permanent or temporary wall, ceiling, or floor system.

### BACKGROUND OF THE INVENTION

This application claims the benefit of U.S. Provisional Application No. 61/183,002 filed Jun. 1, 2009.

Materials utilized in the construction of buildings for providing strength and durability typically provide poor acoustical and sound suppressing and insulating properties.

When these materials are used, it is given that people in homes, hotels, multi-unit apartment housing and office buildings may be subjected to irritating, bothersome noise from an adjacent room or an upper or lower level. In the security and medical fields, there is a definite need to suppress sound because of the nature of the business and legal regulations protecting privacy of health information.

There are two noise sources that typically bombard wall and ceiling floor systems. The first is airborne sound, such as speech or music, and the second is impact sound, such as footsteps or tapping. Building codes have been developed and implemented to reduce noise levels from both sources. These building codes typically require a newly constructed structure to achieve a Sound Transmission Class (STC) rating of at least 50 (or 45 if field tested), as determined by American Standard Test Methods (“ASTM”) Standards E90, E336 and E413, to limit the transmission of airborne sound from one room in the structure to an adjacent room. The building codes also typically require a newly constructed structure to achieve an Impact Insulation Class (IIC) rating of 50 (or 45 if field tested) as determined by ASTM E90, E336, and E492, to limit the transmission of impact sound from one room in the structure to an adjacent room.

### BRIEF DESCRIPTION OF THE DRAWINGS

FIG. 1 is a perspective view of a surface apparatus made in accordance with an embodiment of the present invention.

FIG. 2 is a cross-sectional view of the surface apparatus of FIG. 1.

FIG. 3 is a perspective view of a surface apparatus made in accordance with an additional embodiment of the present invention.

FIG. 4 is a cross-sectional view of the surface apparatus of FIG. 3.

### SUMMARY

Aspects and embodiments of the present invention provide, without limitation, a surface apparatus having sound reducing and fire resistant characteristics comprised of an EVA layer and a fire resistant fabric layer and methods of making a surface apparatus having sound reducing and fire resistant characteristics comprised of an EVA layer and a fire resistant fabric layer.

In aspects of embodiments, the surface apparatus is from about 0.025 inches to about 0.150 inches thick

In one aspect, the surface apparatus is about 0.025 inches to about 0.100 inches thick.

In another aspect, the surface apparatus is or about 0.060 inches to about 0.090 inches thick.

In aspects of embodiments, the fire resistant fabric layer is bonded to the EVA layer.

In aspects of embodiments, the fire resistant fabric layer is comprised of a pattern that facilitates bonding to the EVA layer.

In aspects of embodiments, the EVA layer is comprised of thermoplastic material

In another embodiment, the EVA layer is comprised of thermoplastic material and is further comprised of one or more fillers, one or more processing aids, and combinations thereof.

In aspects of embodiments, the fillers are inorganic fillers, organic fillers, or combinations thereof.

In aspects of embodiments, the fire resistant fabric layer is fire resistant to or above ASTM E84-07 flammability testing class I rating.

In aspects of embodiments, the fire resistant fabric layer is comprised of strands of fibers.

In another aspect of embodiments, the strands of fiber are fiberglass strands or polyester strands.

In aspects of embodiments, the strands are fire resistant fiber strands that meet or exceed the ASTM E84-07 flammability testing as a class I rating.

In aspects of embodiments, the fire resistant fabric layer is comprised of woven fabric or nonwoven fabric.

In aspects of embodiments, the fire resistant fabric layer is conducive to an application of paint.

In another embodiment, an additional fire resistant fabric layer is bonded to the combination of the EVA layer and the fire resistant fabric layer.

In aspects of embodiments, the EVA layer is extruded and at lease one fire resistant fabric layer is bonded to the EVA layer.

In one aspect of embodiments, an additional fire resistant fabric layer is bonded to a fire resistant fabric layer and the combination is bonded to the extruded EVA layer.

In another aspect of embodiments, the EVA layer is extruded, allowed to cool, and reheated to an acceptable temperature prior to bonding at least one fire resistant fabric layer to the extruded EVA layer.

In one aspect of embodiments, the fire resistant fabric layer is bonded to the EVA layer under heat and pressure.

In another aspect of embodiments, an additional fire resistant fabric layer is bonded to the combination of an EVA layer and a fire resistant fabric layer.

In one aspect, the additional fire resistant fabric layer is bonded to the combination of an EVA layer and a fire resistant fabric layer in the presence of bonding aids.

### DETAILED DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms. In the illustrations, the thickness of lines and layers may be exaggerated for clarity.

Aspects of embodiments of the present invention are directed to an article comprised of an EVA layer and at least one fire resistant fabric layer.

The present invention may be used as a sound reducing and fire resistant layer that is affixed to the surface of a permanent or temporary wall, ceiling, or floor system in various applications. Typical uses include, but are not limited to, residential housing, commercial rooms, and offices as well as medical suites and offices.

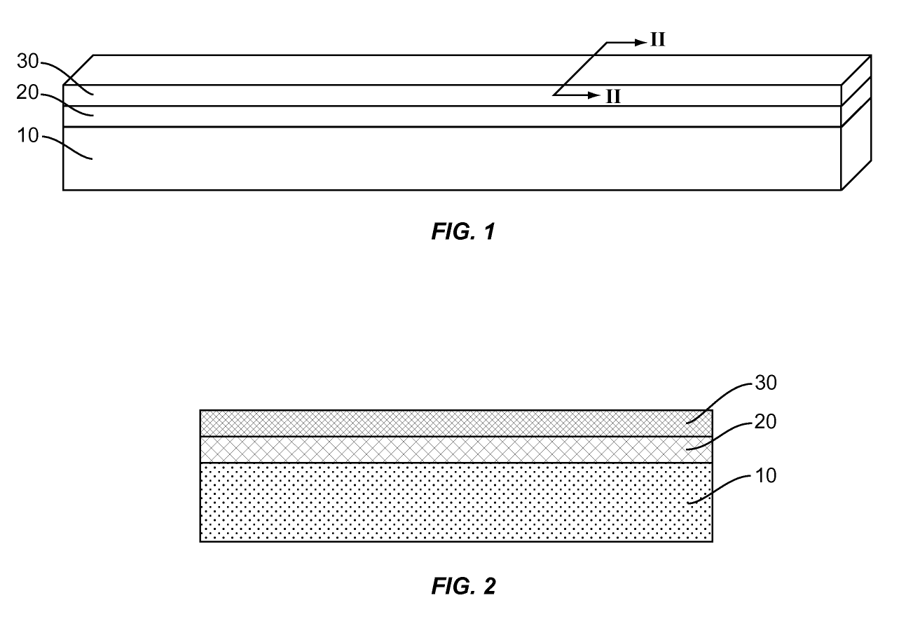

FIG. 1 is a perspective view of a surface apparatus made in accordance with an embodiment of the claimed invention. FIG. 2 is a cross-sectional view of the surface apparatus of FIG. 1. The surface apparatus is comprised of an EVA layer 10, a fire resistant fabric layer 20 and optionally a secondary or additional fire resistant fabric layer 30. It is contemplated that these layers are bonded together in such a manner that the surface apparatus is a composite product which will not separate into its individual components during normal handling for storage, application or use.

The surface apparatus is contemplated to be between about 0.025 inches and about 0.150 inches thick. The surface apparatus may be between about 0.025 inches and about 0.100 inches thick. The surface apparatus may also be between about 0.060 inches and about 0.090 inches thick.

The EVA layer 10 is a thermoplastic material that may be highly filled with organic fillers, inorganic fillers, or a combination thereof to increase the density of the polymer matrix and may additionally contain various processing aids.

In one embodiment, the EVA layer 10 may contain virgin material, such as EVA pellets; a waste-type EVA product, such as EVA part trimmings, offal, or other selvage; other EVA materials known to one skilled in the art; or combinations of the same. The EVA layer 10 may further be highly filled with organic fillers. The organic fillers may contain a relative percentage of reprocessed materials from zero to one hundred percent. Examples of organic fillers include, but are not limited to, calcium carbonate, barium sulfate, hemp, knauf, flax, coconut fiber, jute, similar reinforcing fibrous organic fillers, other organic fillers known to one skilled in the art, and combinations thereof. The organic fillers may further comprise various processing aids to accommodate the masticating of the materials in an extrusion process, such as the processes described below, and extend the final material physical properties. Examples of such processing aids include process oils, tackifiers, other processing aids known to one skilled in the art, and combinations of the same.

In another embodiment, the EVA layer 10 may further be highly filled with inorganic fillers. Examples of such inorganic fillers include fly ash, other inorganic fillers known to one skilled in the art, and combinations of the same. The inorganic filler may further comprise various processing aids to accommodate the masticating of the materials in an extrusion process, such as the processes described below, and extend the final material physical properties. Examples of such processing aids include process oils, tackifiers, other processing aids known to one skilled in the art, and combinations of the same.

The fire resistant fabric layer 20 is a woven or nonwoven fibrous fabric made from continuous fiber strands suitable for fire resistance that meet or exceed the ASTM E84-07 flammability testing as a class I rating. Examples of acceptable fibers include, but are not limited to, fiberglass, poly-acrylonitrile (PAN) fibers, mineral wool fiber, aramid fibers, carbon fibers, polyester fibers, other fire resistant fibers currently known to one having skill in the art, fibers having fire resistance that meet or exceed the ASTM E84-07 flammability testing as a class I rating which may be developed in the future, and combinations of the same. The fire resistant layer 20 may be woven or nonwoven using fiberglass fiber. The acceptable fiber may be woven into a pattern that provides a closed surface area sufficient to protect the EVA layer 10 from the applied flame in the ASTM E84-07 flammability test. This pattern may also provide an open surface area sufficient to provide a receptive bonding surface for the EVA layer 10 during an extrusion process, such as the processes described below, such that a composite product is formed which will not separate into its individual components during normal handling for storage, application or use. The fire resistant fabric layer 20 may be aesthetically pleasing to the layman and may be conducive to an application of commercially available paint. It is contemplated that both latex based and oil based paints should be acceptable for application without extensive surface preparations such as steps necessary for the mechanical bonding or treatment of the surface apparatus surface such as the roughing of the surface, a chemical treatment to create surface tension to assist in the bonding of the paint to the surface of the panel, or a combination of the same.

The optional secondary fire resistant fabric layer 30 is comprised of either a woven or nonwoven type fabric made from fiber strands comprised of materials suitable for fire resistance that meet or exceed the ASTM E84-07 flammability testing as a class I rating. Examples of acceptable fibers include, but are not limited to, fiberglass, PAN fibers, mineral wool fiber, aramid fibers, carbon fibers, polyester fibers, other fire resistant fibers currently known to one having skill in the art, fibers having fire resistance that meet or exceed the ASTM E84-07 flammability testing as a class I rating which may be developed in the future, and combinations of the same. In one aspect of an embodiment, the secondary, additional fire resistant fabric layer 30 is woven or nonwoven using polyester fibers. The secondary, additional fire resistant fabric layer 30 may be of a surface texture suitable for acceptable bonding to the first fire resistant fabric layer such that the composite product will not separate into its individual components during normal handling for storage, application or use. A suitable surface texture may be dependent upon the characteristics of the fibers used to create the first fire resistant fabric layer 20 and the secondary fire resistant fabric layer 30 as would be known to one having ordinary skill in the art.

Similar to the first fire resistant fabric layer 20, the secondary fire resistant fabric layer 30 may also be aesthetically pleasing to the layman and may be conducive to an application of commercially available paint, such as latex based and oil based paints, without extensive surface preparations.

An embodiment of the current invention may include one or more additional fire resistant fabric layers of the same type as disclosed above. Additional fire resistant fabric layers may also be aesthetically pleasing to the layman and may be conducive to an application of commercially available paint, such as latex based and oil based paints, without extensive surface preparations.

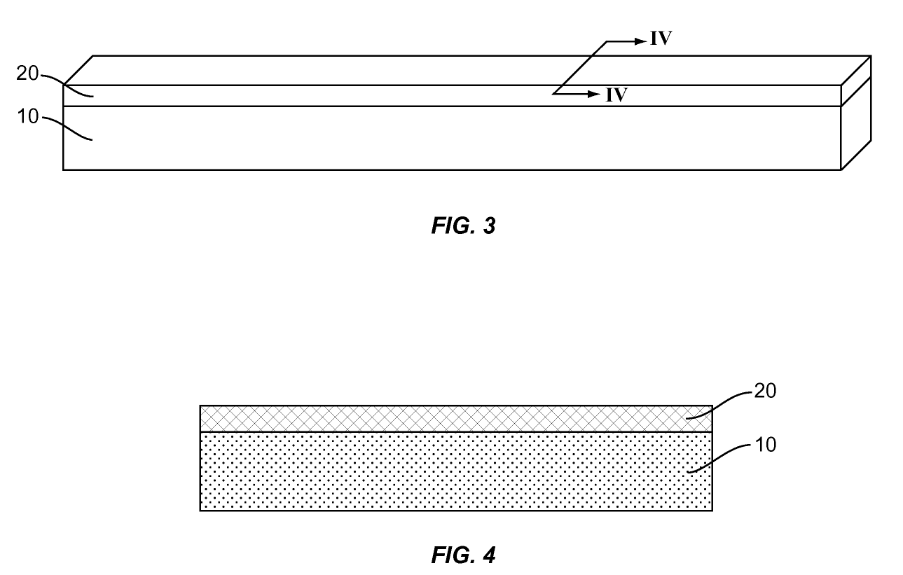

When manufacturing the sound reducing and fire resistant surface apparatus of the present invention, the EVA material is extruded into a hot polymer matrix sheet. The fire resistant fabric layer 20 is then introduced to the EVA layer, and, under heat and pressure, the two materials are bonded to form a two component composite comprised of a bottom layer, EVA 10, and a top layer, fire resistant fabric 20, as seen in FIG. 3. The composite is then cooled, trimmed and either cut into sheet form or rolled into continuous rolls limited in size only by the size of the production line creating the composite. The composite may also be manufactured by first extruding the EVA material and allowing it to cool, then reheating the extruded EVA layer 10 to an acceptable temperature to allow bonding of a fire resistant fabric layer 20 to the EVA layer 10 without the use of bonding aids such as adhesives. A fire resistant fabric layer 20 is then bonded to the heated surface. The composite as seen in FIG. 3 is then cooled, trimmed and either cut into sheet form or rolled into continuous rolls limited in size only by the size of the production line creating the composite.

In one aspect of an embodiment of the present invention, a secondary fire resistant fabric layer 30 may be added to the composite seen in FIG. 3 by bonding a first fire resistant fabric layer 20 to a secondary or additional fire resistant layer 30 prior to the combination of the first fire resistant fabric layer 20 and second fire resistant fabric layer 30 being bonded to the EVA layer 10. The combination of the first fire resistant fabric layer 20 and the second fire resistant fabric layer 30 is applied within the extrusion process in the same manner as described above. The combination of the EVA layer 10, first fire resistant fabric layer 20, and second fire resistant fabric layer 30 forms the composite seen in FIG. 1.

In an additional aspect of an embodiment of the present invention, a secondary fire resistant fabric layer 30 is post-bonded to the composite seen in FIG. 3. In this process, the secondary fire resistant fabric layer 30 is introduced to the fibrous surface of the composite seen in FIG. 3, the first fire resistant fabric layer 20 side, and is bonded to the composite under heat and pressure with or without the addition of an adhesive or other bonding aids to form the final three component composite comprising the EVA layer 10, the first fire resistant fabric layer 20, and the secondary fire resistant fabric layer 30 as seen in FIG. 1.

The composites shown in FIG. 1 and FIG. 3 may be cut into sheet form or rolled into continuous rolls as described above. The sheets or rolls of the composite may be further cut into panels for ease of handling and installation although such modification is not necessary. If the composite is cut into panels for ease of handling and installation, the panels may be any size convenient for handling and installation. For example, the composite may be cut into about four foot by about eight foot panel sections or about four foot by about ten foot panel sections. However, one having ordinary skill in the art will appreciate that the panel could be cut into any geometric shape such as a square, circle, or octagon. The composites shown in FIG. 1 and FIG. 3 are flexible in nature such that panels, sheets or rolls of the composite may be applied similarly to wallpaper. The flexural modulus of the composite may be between about 10,000 and about 100,000 Pascals as determined by ASTM D790-07e1. The flexural modulus of the composite may further be between about 40,000 and about 50,000 Pascals as determined by ASTM D790-07e1.

The surface apparatus described herein is a thin, flexible surface covering with sound reducing and fire resistance properties. The thin and flexible nature of the surface apparatus allows it to be easily installed without additional preparation or articles such as frames from which other surface coverings may necessarily be attached.

What is claimed is:

1. A surface apparatus comprising:
an EVA layer; and
at least one fire resistant fabric layer bonded to the surface of said EVA layer;
wherein said surface apparatus is about 0.025 inches to about 0.150 inches thick.

2. The surface apparatus according to claim 1, wherein said surface apparatus is about 0.025 inches to about 0.100 inches thick.

3. The surface apparatus according to claim 1, wherein said surface apparatus is about 0.060 inches to about 0.090 inches thick.

4. The surface apparatus according to claim 1, wherein said EVA layer comprises at least one thermoplastic material.

5. The surface apparatus according to claim 4, wherein said EVA layer further comprises:
one or more fillers;
one or more processing aids; or
a combination thereof.

6. The surface apparatus according to claim 5, wherein said one or more fillers comprise inorganic fillers, organic fillers, or any combination thereof.

7. The surface apparatus according to claim 1, wherein said fire resistant fabric layer is fire resistant to or above the ASTM E84-07 flammability testing class I rating.

8. The surface apparatus according to claim 1, wherein said fire resistant fabric layer comprises strands of one or more fibers.

9. The surface apparatus according to claim 8, wherein said strands of one or more fibers are fire resistance fiber strands that meet or exceed the ASTM E84-07 flammability testing as a class I rating.

10. The surface apparatus according to claim 8, wherein said fiber strands are strands selected from the group consisting of fiberglass strands and polyester strands.

11. The surface apparatus according to claim 1, wherein said fire resistant fabric layer is a fabric selected from the group consisting of woven fabric or nonwoven fabric.

12. The surface apparatus according to claim 1, wherein said fire resistant fabric layer further comprises a pattern that facilitates bonding of said fire resistant fabric layer to said EVA layer.

13. The surface apparatus according to claim 1, wherein said fire resistant fabric layer is conducive to an application of paint.

14. The surface apparatus according to claim 1, further comprising a second fire resistant fabric layer bonded to the combination of said EVA layer and said fire resistant fabric layer.

15. A method of making a surface apparatus comprising the steps of:
bonding a first fire resistant layer to a second fire resistant layer;
extruding an EVA layer; and
bonding the combination of said first fire resistant layer and said second fire resistant layer to said EVA layer;
wherein said surface apparatus is about 0.025 inches to about 0.150 inches thick.

16. A method of making a surface apparatus comprising the steps of:
extruding an EVA layer; and
bonding at least one fire resistant fabric layer to said EVA layer;
wherein said surface apparatus is about 0.025 inches to about 0.150 inches thick.

17. The method of making a surface apparatus of claim 16, wherein said at least one fire resistant fabric layer is bonded to the surface of said extruded EVA layer under heat and pressure.

18. The method of making a surface apparatus of claim 16, further comprising the step of bonding at least one additional fire resistant fabric layer to the combination of said EVA layer and said fire resistant fabric layer.

19. The method of making a surface apparatus according to claim 18, wherein said additional fire resistant fabric layer is bonded to said fire resistant fabric layer in the presence of bonding aids.

20. The method of making a surface apparatus according to claim 16, further comprising the step of reheating the extruded EVA layer to an acceptable temperature prior to bonding said at least one fire resistant fabric layer to the surface of said extruded EVA layer.

21. The method of making a surface apparatus according to claim 16, wherein said EVA layer comprises at least one thermoplastic material.

22. The method of making a surface apparatus according to claim 16, wherein said EVA layer further comprises:
one or more fillers;
one or more processing aids; or
a combination thereof.

23. The method of making a surface apparatus according to claim 22, wherein said one or more fillers comprise inorganic fillers, organic fillers, or any combination thereof.

24. The method of making a surface apparatus according to claim 16, wherein said fire resistant fabric layer is fire resistant to or above the ASTM E84-07 flammability testing class I rating.

25. The method of making a surface apparatus according to claim 16, wherein said fire resistant fabric layer comprises strands of one or more fibers.

26. The method of making a surface apparatus according to claim 25, wherein said strands of one or more fibers are fire resistance fiber strands that meet or exceed the ASTM E84-07 flammability testing as a class I rating.

27. The method of making a surface apparatus according to claim 25, wherein said fiber strands are strands selected from the group consisting of fiberglass strands and polyester strands.

28. The method of making a surface apparatus according to claim 16, wherein said fire resistant fabric layer is a fabric selected from the group consisting of woven fabric or nonwoven fabric.

29. The method of making a surface apparatus according to claim 16, wherein said fire resistant fabric layer further comprises a pattern that facilitates bonding of said fire resistant fabric layer to said EVA layer.

30. The method of making a surface apparatus according to claim 16, wherein said fire resistant fabric layer is conducive to an application of paint.
